(19) United States
(12) Patent Application Publication
(10) Pub. No.: US 2025/0247639 A1
(43) Pub. Date: Jul. 31, 2025

(54) VIBRATION DEVICE

(71) Applicant: neten Inc., Kofu-shi (JP)

(72) Inventors: Tetsuya NAKAYAMA, Kofu-shi (JP); Tatsuro HORIUCHI, Kofu-shi (JP)

(73) Assignee: neten Inc., Kofu-shi (JP)

(21) Appl. No.: 19/000,625

(22) Filed: Dec. 23, 2024

(30) Foreign Application Priority Data
Jan. 29, 2024 (JP) 2024-010826

(51) Int. Cl. H04R 1/02; H04R 1/24; H04R 17/00

(52) U.S. Cl. CPC H04R 1/025; H04R 1/028; H04R 1/24; H04R 17/00; H04R 2420/07

(57) ABSTRACT

A vibration device that vibrates in accordance with a reproduction signal. The vibration device includes: a vibration generation section including a speaker that is configured to generate a sound wave in accordance with the reproduction signal, to thereby generate vibration; a power generation section including a piezoelectric element that generates a current corresponding to the reproduction signal by the vibration of the vibration generation section; an electromagnetic wave generation section including a coil substrate, into which the current generated by the power generation section flows to thereby generate an electromagnetic wave that is spatially radiated; and a body section including a cylindrical case that accommodates the vibration generation section, the power generation section, and the electromagnetic wave generation section. The vibration generated by the vibration generation section is transmitted to a user via the case.

### CROSS-REFERENCE TO RELATED APPLICATION

This application is based upon and claims the benefit of priority of the prior Japanese Patent Application No. 2024-010826 filed on Jan. 29, 2024, the entire contents of which are incorporated herein by reference.

### BACKGROUND

### 1. Field of the Invention

The present disclosure relates to a vibration device and a method for transmitting vibration to a body of a person.

### 2. Description of the Related Art

Conventionally, for example, like an apparatus for bodily sensation of bone vibration, a method using the apparatus for bodily sensation of bone vibration, a low frequency vibration device, furniture with a low frequency vibration device built therein, and a transportation vehicle with a low frequency vibration device built in a seat, a technology of providing connection to a contents reproduction device that reproduces audio signals via an amplifier, generating vibration in response to a signal in a low frequency band in a human audible range among the audio signals to transmit the vibration to a body of a person or conduct the vibration to a bone of the person has been known.

Also, a massage probe that includes a pair of electrode sections and can cause a current to flow from the electrode sections by power supply from a massaging machine has been known.

### SUMMARY

A vibration device according to the present disclosure includes a vibration generation section including a speaker that vibrates in accordance with a reproduction signal, a power generation section including a piezoelectric element that generates a weak current corresponding to the reproduction signal by vibration of the vibration generation section, an electromagnetic wave generation section including a coil substrate into which the weak current generated by the power generation section flows, and a body section including a cylindrical case that stores the vibration generation section, the power generation section, and the electromagnetic wave generation section. The vibration device is arranged and configured such that the vibration generated by the vibration generation section is transmitted to a body of a person via the case or an attachment section attached to the case and vibration generated by a sound wave generated by the speaker is transmitted to the body of the person via a lower portion of the case, and a weak electromagnetic wave generated by the electromagnetic wave generation section is spatially radiated.

A vibration device according to the present disclosure includes a vibration generation section including a speaker that vibrates in accordance with a reproduction signal, a power generation section including a piezoelectric element that generates a weak current corresponding to the reproduction signal by vibration of the vibration generation section, and a body section including a cylindrical case that stores the vibration generation section and the power generation section. The vibration device is configured such that the vibration generated by the vibration generation section is transmitted to a body of a person via the case or a metal attachment section attached to the case and vibration generated by a sound wave generated by the speaker is transmitted to the body of the person via a lower portion of the case, and the weak current generated by the piezoelectric element is transmitted to the body of the person via the metal attachment section.

According to the vibration devices described above, vibration and a weak current generated in accordance with a reproduction signal can be effectively used.

### BRIEF DESCRIPTION OF THE DRAWINGS

FIG. 1 is a perspective disassembled view illustrating a vibration device according to a first embodiment.

FIG. 2 is a block diagram illustrating an outline of a configuration of the vibration device according to the first embodiment.

FIG. 3 is a block diagram illustrating an outline of a vibration generation section according to the first embodiment.

FIG. 4 is a perspective disassembled view illustrating a vibration device according to a first modified example of the first embodiment.

FIG. 5 is a perspective view illustrating the vibration device according to the first modified example of the first embodiment.

FIG. 6 is a cross-sectional view illustrating a state where a container insertion-type attachment is attached to a vibration device according to a second modified example of the first embodiment.

FIG. 7 is a perspective view illustrating a container holding attachment according to the second modified example of the first embodiment.

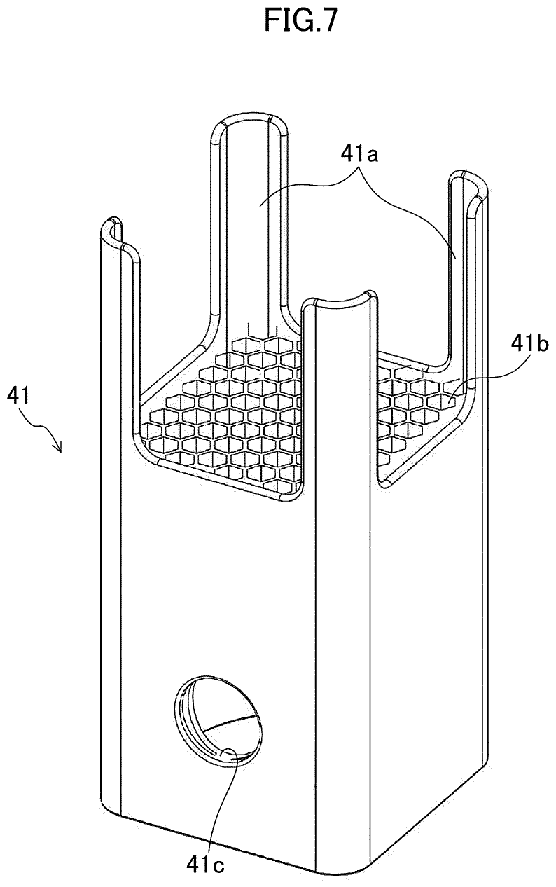

FIG. 8 is a bottom view illustrating the container holding attachment according to the second modified example of the first embodiment.

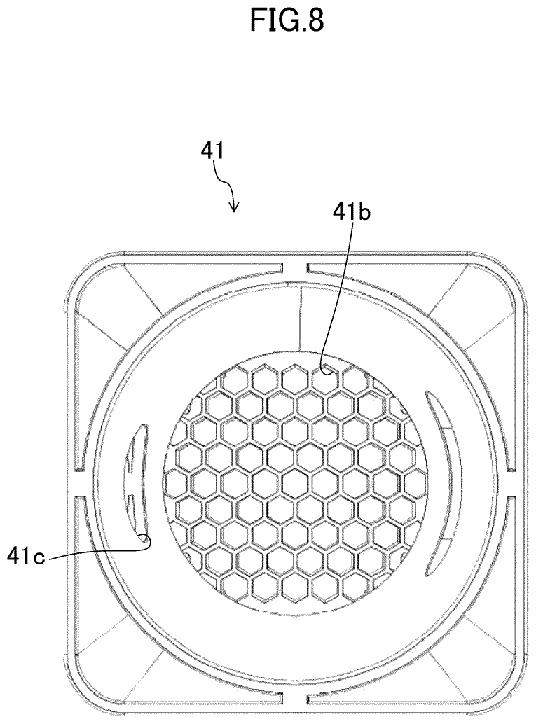

FIG. 9 is a perspective view illustrating a vibration device according to a second embodiment.

FIG. 10 is a block diagram illustrating an outline of a vibration generation section according to the second embodiment.

FIG. 11 is a block diagram illustrating an outline of a configuration of the vibration device according to the second embodiment.

FIG. 12 is a perspective disassembled view illustrating a vibration device according to a third embodiment.

### DETAILED DESCRIPTION

Embodiments will be described below with reference to the accompanying drawings.

Specifically, according to a first aspect of the present disclosure, a vibration device includes a vibration generation section including a vibration body that vibrates in accordance with a reproduction signal, a power generation section including a piezoelectric element that generates a weak current corresponding to the reproduction signal by vibration of the vibration generation section, an electromagnetic wave generation section including a coil section into which the weak current generated by the power generation section flows, and a body section including a case that stores the vibration generation section, the power generation section, and the electromagnetic wave generation section. The vibration device is arranged and configured such that a weak electromagnetic wave generated by the electromagnetic wave generation section is spatially radiated.

According to the configuration described above, the vibration generated by the vibration body of the vibration generation section is converted to electric power by the power generation section including the piezoelectric element, such as a piezo element or the like. Specifically, vibration conducted from the case and air vibration by air propagation are transmitted to the piezoelectric element, the weak current generated by the piezoelectric element flows into the coil section to generate a fine electromagnetic wave, and the electromagnetic wave can be applied to a body of a person. The vibration and the electromagnetic wave can be also applied to a liquid, such as water or the like. The vibration generated by the reproduction signal is given as a sound wave, and furthermore, as an electromagnetic wave to different areas at the same time. On the other hand, the applied electromagnetic wave from the electromagnetic wave generation section is finer, as compared to energy generated in the vibration generation section. In this device, for electromagnetic wave therapeutic purposes, effects of both sound wave vibration and an electromagnetic wave based on the sound wave vibration can be given. The applied electromagnetic wave from the electromagnetic wave generation section is very fine and, unlike general electromagnetic waves, does not give uncomfortableness to a human body. On the other hand, this is an approach that causes fine change in a physical property, and has a characteristic that a major effect is given by vibration (a sound wave) and a secondary effect is given in an electromagnetic wave area.

According to a second aspect of the present disclosure, furthermore, the vibration device is configured such that the body section includes an attachable and removable attachment section, and the vibration generated by the vibration generation section is transmitted to the body of the person via the attachment section.

According to the configuration described above, transmission of the vibration can be effectively performed by attaching the attachment section having, for example, an uneven surface and causing the attachment section to locally contact a subject (an affected part of the body of the person).

According to a third aspect of the present disclosure, furthermore, the body section includes an attachable and removable attachment section in which a container containing water is stored, and the vibration generated by the vibration generation section and the weak electromagnetic wave generated by the electromagnetic wave generation section are transmitted to the water in the container stored in the attachment section.

There is a specialized field of research in an area of vibration and a weak electromagnetic wave given to water and effects thereof on physical properties of the water and, according to the configuration described above, the vibration device described above is a device that promotes experiments in the research field. When a certain property is activated by giving vibration or a weak electromagnetic wave to water, it is an effective experiment to examine whether there is a perception change due to drinking a drink containing the water.

According to a fourth aspect of the present disclosure, a vibration device includes a vibration generation section including a vibration body that vibrates in accordance with a reproduction signal, a power generation section including a piezoelectric element that generates a weak current corresponding to the reproduction signal by vibration of the vibration generation section, and a body section including a case that stores the vibration generation section and the power generation section. The vibration device is configured such that the vibration generated by the vibration generation section is transmitted to the body of the person via the case or an attachment section attached to the case, and the weak current generated by the piezoelectric element is transmitted to the body of the person via the attachment section.

According to the configuration described above, the vibration is effectively transmitted to the body of the person via the attachment section and the weak current is transmitted to the body of the person, so that injury or pain can be reduced. The weak current does not give an irritating stimulation, unlike a low frequency current, and an effect that recovery of body tissues is expedited can be also expected.

According to a fifth aspect of the present disclosure, furthermore, the vibration generation section is configured to obtain the reproduction signal via a wireless communication or from a recording medium.

According to the configuration described above, a favorite reproduction signal can be easily used on the vibration device. Using a wireless communication, control via a smartphone app is enabled, and a plurality of files in accordance with respective purposes of use can be successively and selectively reproduced.

According to a sixth aspect of the present disclosure, furthermore, the reproduction signal includes an aperiodic continuous signal obtained through waveform synthesis by connecting analog waveforms of one cycle wavelength, among analog waveforms having different basic cycles, in succession.

According to the configuration described above, it is prevented that the body of the person gets used to a periodic signal, and regular stimulation switching that is considered effective particularly for bone fracture treatment is not needed.

According to a seventh aspect of the present disclosure, a method for transmitting vibration includes generating vibration and a weak current in accordance with a reproduction signal and transmitting the vibration and the weak current to a body of a person.

According to the configuration described above, the vibration generated in accordance with the reproduction signal is transmitted to the body of the person and the weak current is transmitted to the body of the person, so that injury or pain can be reduced. The weak current does not give an irritating stimulation, unlike a low frequency current, and an effect that recovery of body tissues is expedited can be expected.

According to an eighth aspect of the present disclosure, furthermore, the vibration and the weak current are transmitted directly or indirectly to the body of the person, and a weak electromagnetic wave is generated by the weak current generated by the vibration and is applied to the body of the person.

According to a ninth aspect of the present disclosure, the vibration device is configured such that vibration and a weak current are generated in accordance with a reproduction signal, a weak electromagnetic wave is generated by the weak current generated by the vibration, and the vibration is transmitted directly and indirectly to the body of the person, and the weak electromagnetic wave is applied to the body of the person.

According to the configurations described above, the vibration generated in accordance with the reproduction signal is given as a sound wave, and furthermore, as an electromagnetic wave to different areas at the same time. For electromagnetic wave therapeutic purposes, effects of both sound wave vibration and an electromagnetic wave based on the sound wave vibration can be given to the body of the person. The applied electromagnetic wave from the electromagnetic wave generation section is very fine and, unlike general electromagnetic waves, does not give uncomfortableness to a human body. On the other hand, this is an approach that causes fine change in a physical property, and has a characteristic that a major effect is given by vibration (a sound wave) and a secondary effect is given in an electromagnetic wave area.

According to a tenth aspect of the present disclosure, furthermore, as the reproduction signal, an aperiodic continuous signal obtained through waveform synthesis by connecting analog waveforms of one cycle wavelength, among analog waveforms having different basic cycles, in succession is used.

According to the configuration described above, it is prevented that a body of a person gets used to a periodic signal, and regular stimulation switching that is considered effective particularly for bone fracture treatment is not needed.

As has been described above, according to the present disclosure, vibration and a weak current generated in accordance with a reproduction signal can be effectively used.

### First Embodiment

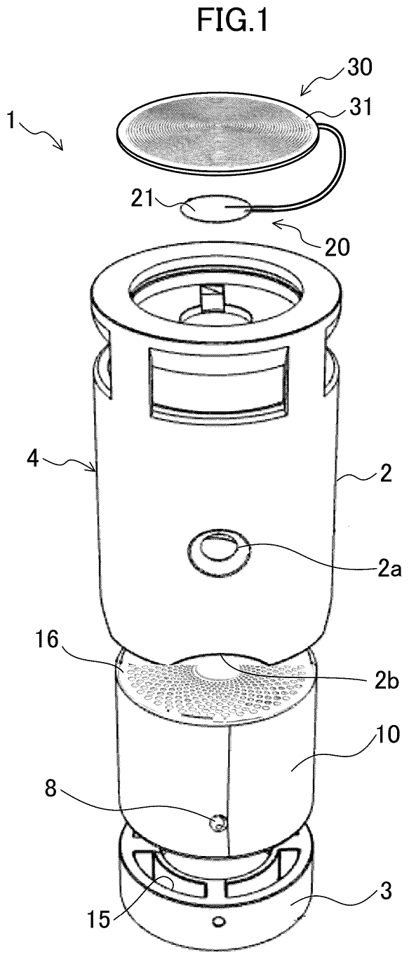

FIG. 1 illustrates a vibration device 1 according to a first embodiment. The vibration device 1 includes a cylindrical case 2, for example, formed of a resin molded product and a body section 4 including a bottom surface cover 3 that closes a lower portion of the case 2. The case 2 may be manufactured by a 3D printer, and may be manufactured by injection molding. The case 2 may be formed of metal, such as stainless, titanium, or the like. A plurality of arc-shaped notches 2b are formed at intervals in a lower end of the case 2.

A vibration generation section 10, a power generation section 20, and an electromagnetic wave generation section 30 are built in the body section 4.

The vibration generation section 10 receives a reproduction signal from a transmission section 5 via a wireless communication. The transmission section 5 is a wireless communication device, such as a smartphone 6, a personal computer 7, or the like, using, for example, Bluetooth (registered trademark). Specifically, a sound source file including a reproduction signal downloaded to the smartphone 6 or the personal computer 7 is transmitted to the vibration generation section 10 via Bluetooth. Each of the smartphone 6 and the personal computer 7 includes a reproduction signal data storage section 9, such as a memory or the like, that stores the reproduction signal.

### Reproduction-Dedicated File

A sound source of a reproduction signal included in a dedicated file prepared especially for the vibration device 1 in order to achieve particular effects may be a low-frequency sound source vibration of which is likely to be strongly sensed, a sound source, such as a crystal bowl, that abundantly includes harmonic sounds, or the like, regardless of a type of a periodic signal or an aperiodic signal.

For example, the reproduction signal may include an aperiodic continuous signal obtained through waveform synthesis by connecting analog waveforms of one cycle wavelength, among analog waveforms having different basic cycles, in succession, as in, for example, Japanese Patent No. 6656648. In this case, it is prevented that a body of a person gets used to a periodic signal, and regular simulation switching that is considered effective particularly for bone fracture treatment is not needed.

For example, as described above, by connecting the smartphone 6 and the vibration generation section 10 via Bluetooth, control using a smartphone app is enabled, and various files in accordance with respective purposes of use can be successively and selectively reproduced.

### Configuration of Vibration Generation Section

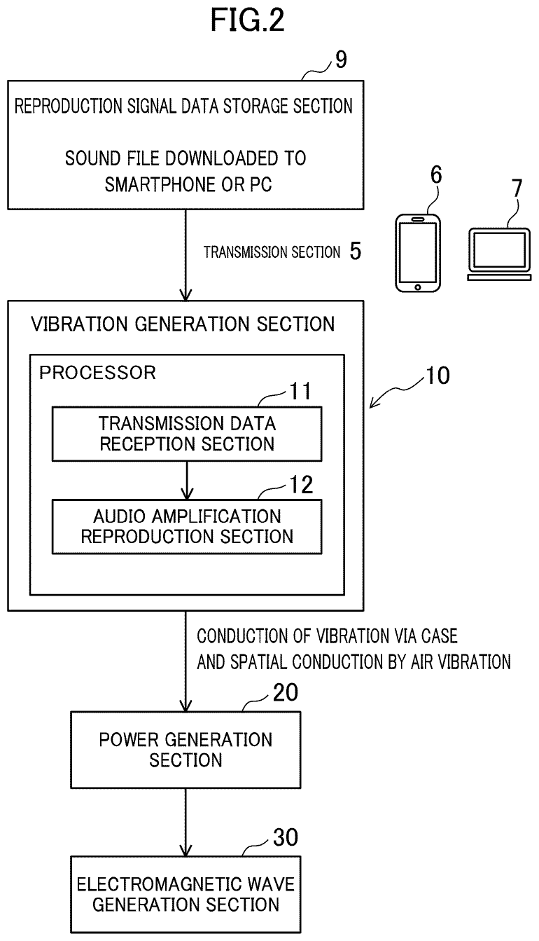

The vibration generation section 10 vibrates in accordance with the various reproduction signals described above and, as an outline thereof is enlarged and illustrated in FIG. 2, includes a transmission data reception section 11 as a transmission data receiver and an audio amplification reproduction section 12 that amplifies data received by the transmission data reception section 11.

The vibration generation section 10 includes an upper speaker 13 and a bass sound reproduction speaker 14 as vibration bodies each of which reproduces a reproduction signal amplified by the audio amplification reproduction section 12. Note that, as a device that generates a signal from the reproduction signal, a vibration generation device, such as a vibrotransducer described in Japanese Unexamined Patent Publication No. 2020-043393 or the like, not a speaker that reproduces the signal as sound, may be used.

Bass sound of the bass sound reproduction speaker 14 is emitted from an opening section 15. Sound from the upper speaker 13 is emitted from a grill 16 provided at an upper end of the vibration generation section 10. A configuration of the upper speaker 13 is not particularly limited, but a speaker having a different configuration from that of the bass sound reproduction speaker 14 is preferably used as the upper speaker 13. The configurations of the speakers are not limited thereto, and the number of speakers may be one and may be three or more.

Note that, although not illustrated in detail, power is supplied from a power source, such as a rechargeable battery or the like, to the vibration generation section 10. The power is supplied when a switch 8 is turned on. In accordance with the switch 8, the case 2 is provided with an opening 2a for a switch.

### Configuration of Power Generation Section

As illustrated in FIG. 1, the power generation section 20 includes, for example, a piezoelectric element 21 that is also called piezo element. The piezoelectric element 21 includes a piezoelectric substance formed of a crystal or a ferroelectric ceramic and, when the piezoelectric element 21 receives vibration, the piezoelectric element 21 generates a weak current from an electrical wire connected to the piezoelectric substance. Thus, the power generation section 20 can be caused to generate a weak current corresponding to a reproduction signal by vibration of the vibration generation section 10.

### Configuration of Electromagnetic Wave Generation Section

The vibration device 1 also includes the electromagnetic wave generation section 30 including a coil section 31 into which the weak current generated by the power generation section 20 flows. In this embodiment, as the coil section 31, a coil substrate that is also called so-called zero magnetic field coil described, for example, in a Japanese Patent No. 6624702 may be used, and a normal spiral coil substrate may be used.

The electromagnetic wave generation section 30 is arranged and configured such that a weak electromagnetic wave generated by the coil section 31 is spatially radiated.

### Operation of Vibration Device

Next, an operation of the vibration device 1 according to this embodiment will be described.

In this embodiment, vibration and a weak current are generated in accordance with a reproduction signal, and the vibration and the weak current are directly or indirectly transmitted to a body of a person while a weak electromagnetic wave generated by the weak current generated by the vibration is applied to the body of the person.

Specifically, as illustrated in FIG. 2, a favorite reproduction signal is downloaded to the reproduction signal data storage section 9 of the smartphone 6 or the personal computer 7 in advance. As the reproduction signal, an aperiodic continuous signal obtained through waveform synthesis by connecting analog waveforms of one cycle wavelength, among analog waveforms having different basic cycles, in succession may be used.

When the vibration device 1 is used, reproduction signal data is transmitted to the vibration device 1, for example, using Bluetooth (registered trademark). In this embodiment, the favorite reproduction signal can be easily used on the vibration device 1. When the reproduction signal data is wirelessly transmitted, control by a smartphone app is enabled, and a plurality of files in accordance with respective purposes of use can be successively and selectively reproduced.

The transmission data reception section 11 of the vibration generation section 10 receives reproduction signal data via a wireless communication, the audio amplification reproduction section 12 amplifies a sound, and a signal is transmitted to the upper speaker 13 and the bass sound reproduction speaker 14.

The sound corresponding to the reproduction signal is emitted, and thus, the case 2 vibrates and surrounding air vibrates.

The piezoelectric element 21 of the power generation section 20 receives the vibrations and thus generates a weak current in accordance with the reproduction signal.

Then, the weak current is transmitted to the coil section 31 of the electromagnetic wave generation section 30 via the electrical wire. The coil section 31 generates a weak electromagnetic wave in accordance with the weak current.

In that state, the vibration and the weak current are directly or indirectly transmitted to the body of the person via the case 2 and the weak electromagnetic wave generated by the weak current generated by the vibration is applied to the body of the person. At this time, the weak electromagnetic wave corresponding to the reproduction signal supplied to the vibration generation section 10 is generated. When the case 2 is closely adhered or press adhered directly to a subject (the body of the person or the like), vibration transmitted to the piezoelectric element 21 fluctuates in accordance with a degree of close adhesion or press-adhesion. That is, it is recognized that an intensity of the electromagnetic wave that is applied to the body of the person or the like varies in a relationship with the subject.

As described above, in this embodiment, vibration conducted from the case 2 and air vibration by air propagation are transmitted to the piezoelectric element 21, the weak current generated by the piezoelectric element 21 flows into the coil section 31, so that a fine electromagnetic wave is generated, and the electromagnetic wave can be applied to the body of the person.

The vibration generated in accordance with the reproduction signal is given as a sound wave, and furthermore, as an electromagnetic wave to different areas at the same time.

On the other hand, the applied electromagnetic wave from the electromagnetic wave generation section 30 is finer, as compared to energy generated in the vibration generation section 10. In this device, for electromagnetic wave therapeutic purposes, effects of both sound wave vibration and an electromagnetic wave based on the sound wave vibration can be given. The applied electromagnetic wave from the electromagnetic wave generation section 30 is very fine and, unlike general electromagnetic waves, does not give uncomfortableness to a human body. On the other hand, this is an approach that causes fine change in a physical property, and has a characteristic that a major effect is given by vibration (a sound wave) and a secondary effect is given in an electromagnetic wave area.

By using the reproduction signal including an aperiodic continuous signal obtained through waveform synthesis by connecting analog waveforms of one cycle wavelength, among analog waveforms having different basic cycles, in succession, it is prevented that the body of the person gets used to a periodic signal, and regular stimulation switching that is considered effective particularly for bone fracture treatment is not needed.

Therefore, according to the vibration device 1 according to this embodiment, vibration and a weak current generated in accordance with a reproduction signal can be effectively used.

### First Modified Example

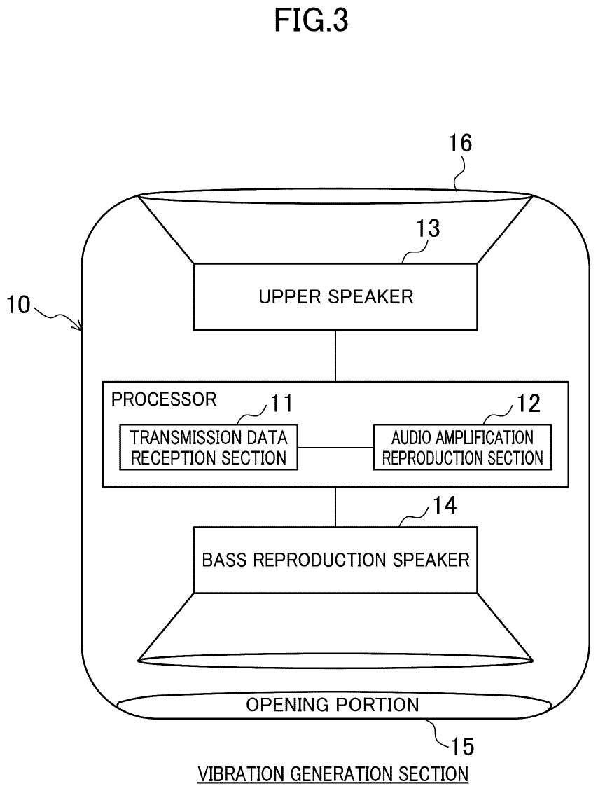

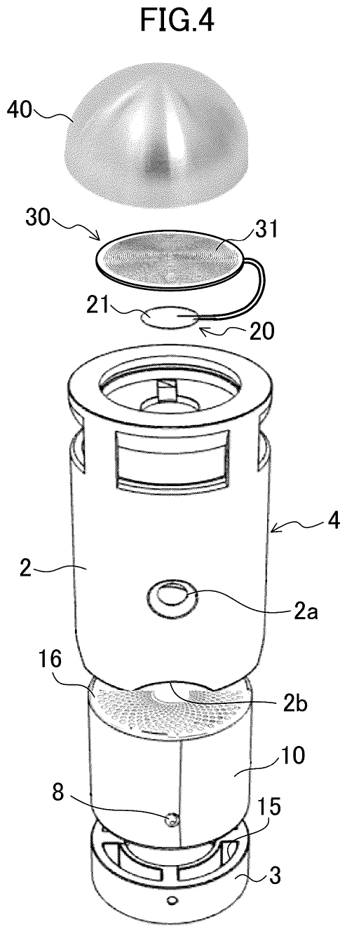

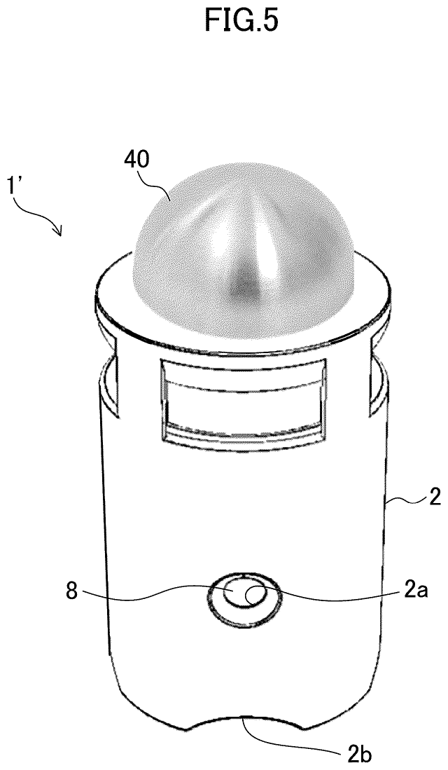

FIG. 4 and FIG. 5 illustrate a vibration device 1′ according to a first modified example of the first embodiment. The first modified example is different from the first embodiment in that a vibration transmission attachment 40 is provided. Note that, in each modified example and each embodiment that will be described below, the same component as a corresponding component of in FIG. 1 to FIG. 3 will be denoted by the same reference sign as that of the corresponding component, and detailed description thereof will be omitted.

The body section 4 incudes the vibration transmission attachment 40 as an attachable and removable attachment section. Although a shape and a material of the vibration transmission attachment 40 are not particularly limited, for example, the vibration transmission attachment 40 is formed of, for example, a press-molded stainless steel plate having a dome shape. The vibration transmission attachment 40 may be a resin molded product, and may be formed of a material, such as titanium or the like, that is less likely to cause metal allergy.

In this modified example, vibration generated by the vibration generation section 10 is effectively transmitted by pressing the vibration transmission attachment 40 against a necessary part of the body of the person. Vibration transmission can be effectively performed by causing the vibration transmission attachment 40 to locally contact a subject (a so-called affected part of the body of the person). For example, the vibration transmission attachment 40 can be pressed with moderate strength against an area on ribs that feels pleasant when being pressed.

### Second Modified Example

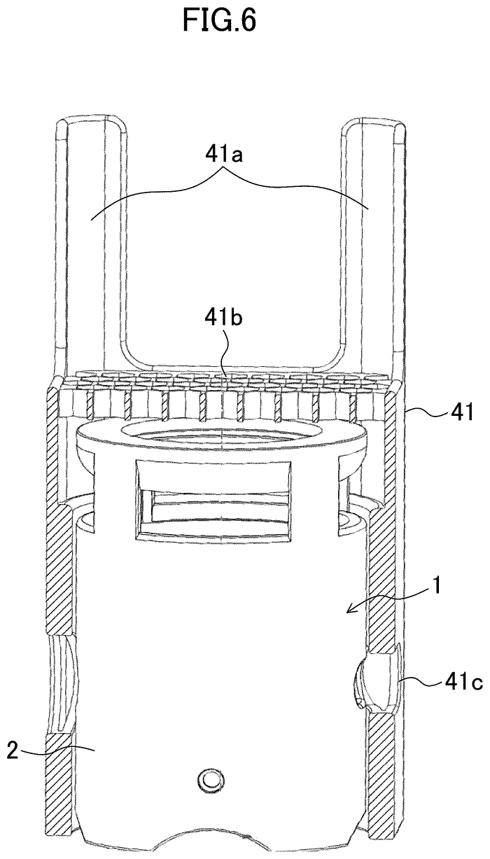

FIG. 6 illustrates a second modified example of the first embodiment. The second modified example is different from the first embodiment in that a container insertion-type attachment 41 is provided.

The container insertion-type attachment 41 of this modified example is, for example, a resin molded product that is inexpensive and can be molded into a complex shape, includes four rod-shaped container support sections 41a on an upper side of a cylindrical body, and base ends thereof are connected to a honeycomb-shaped mounting section 41b on which a bottom surface of a container is mounted. A hole shape of the mounting section is not limited to a honeycomb shape. When a switch exposure opening section 41c is provided in order to expose the switch 8 of the vibration device 1, an excellent operability can be achieved.

This modified example can be applied to transmission of vibration in a special pattern to water. The container insertion-type attachment 41 optimized for a drink is configured such that, for example, an unillustrated pet bottle can be inserted thereto.

There is a specialized field of research in an area of vibration given to water and effects thereof on physical properties of the water, and the vibration device 1′ is a device that promotes experiments in the research field.

When a certain property is activated by giving vibration to water, it is an effective experiment to examine whether there is a perception change due to drinking a drink containing the water.

Since a majority of a human body is made of water, it is recognized that, in terms of effects on the human body, change in the water is an important field of research. Note that a target liquid is not necessarily limited to water.

### Second Embodiment

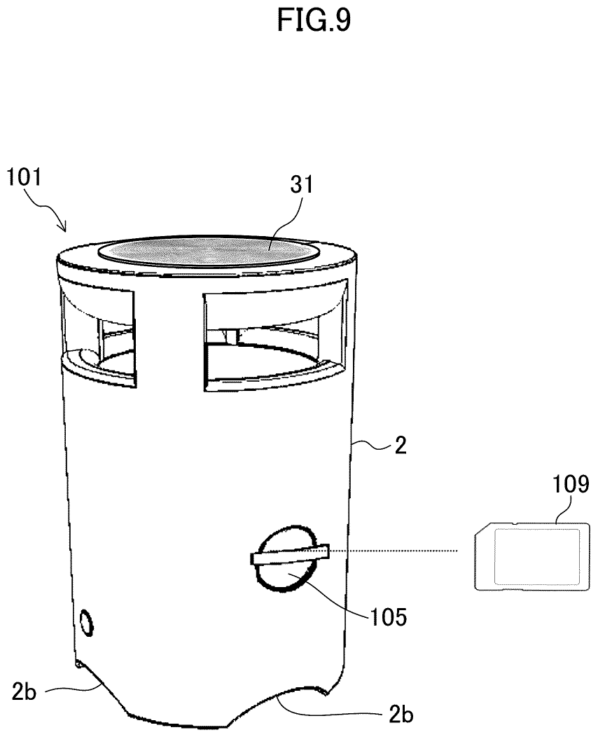

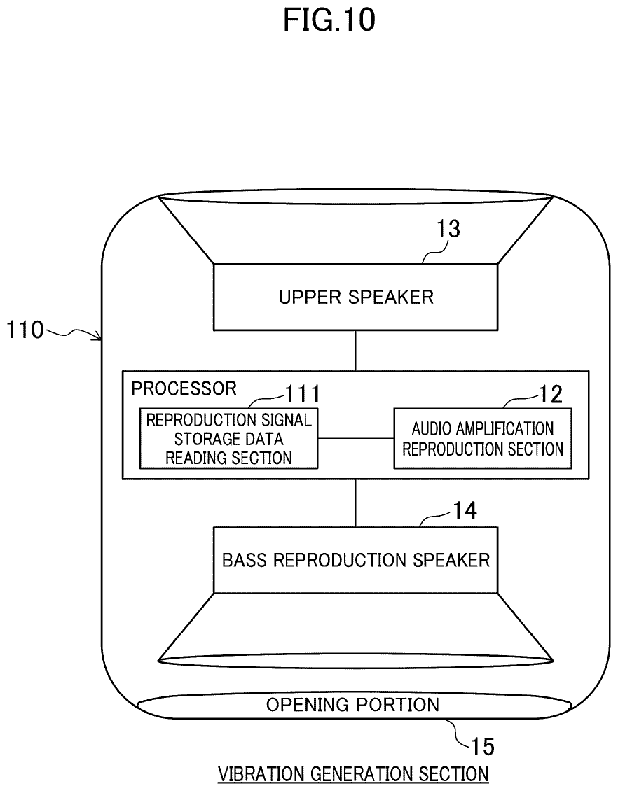

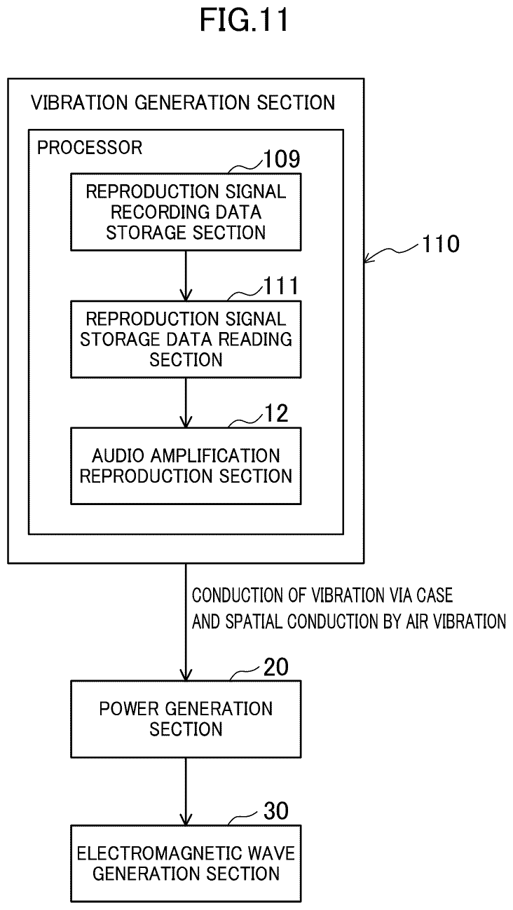

FIG. 9 to FIG. 11 illustrate a vibration device 101 according to a second embodiment. The vibration device 101 is different from the vibration device 1 of the first embodiment in that a different method for transmitting a reproduction signal is used.

In this embodiment, as a device used for transmitting a reproduction signal, unlike the first embodiment, a wireless communication device is not used, but a recording medium 109, such as a SD (registered trademark) card or the like, as a reproduction signal data storage section, is used, and data recorded therein is transmitted to a vibration generation section 110.

Specifically, in this embodiment, the case 2 is provided with a card insertion section as a transmission section 105. The transmission section 105 includes a reproduction signal data reading section 111, and the reproduction signal data reading section 111 reads reproduction signal data from the SD card inserted in the card insertion section. Then, the reproduction signal data is sent as the reproduction signal to the audio amplification reproduction section 12, and the audio amplification reproduction section 12 amplifies the reproduction signal and transmits it to the upper speaker 13 and the bass sound reproduction speaker 14. This point is the same as in the first embodiment.

Since, except for a method for reading a reproduction signal, the second embodiment is the same as the first embodiment, description of an operation of the vibration device 101 of this embodiment is omitted, but the same work effects as those of the first embodiment can be also achieved in this embodiment.

### Third Embodiment

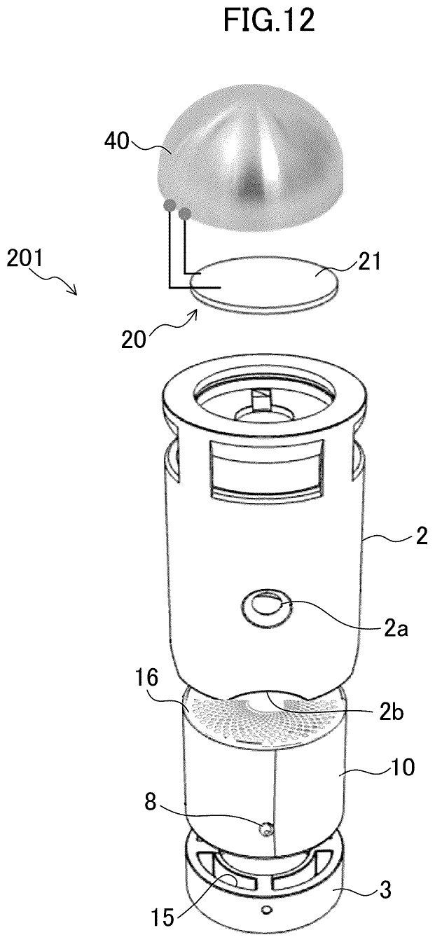

FIG. 12 illustrates a vibration device 201 according to a third embodiment. The third embodiment is different from the first and second embodiments in that the coil section 31 is not provided.

In this embodiment, the weak current generated in the piezoelectric element 21 by vibration is not caused to flow in the coil section 31 but is caused to directly flow into the vibration transmission attachment 40.

It can be said that this embodiment is specialized for therapeutic use in which vibration and a weak current are utilized.

In this embodiment, when the switch 8 is turned on, the upper speaker 13 and the bass sound reproduction speaker 14 vibrate in accordance with a reproduction signal, and the piezoelectric element 21 generates a weak current in accordance with the reproduction signal by the vibration.

The vibration transmission attachment 40 is formed of metal, and the weak current from the piezoelectric element 21 flows thereinto. Therefore, when the vibration transmission attachment 40 is pressed against the body of the person, vibration of the vibration transmission attachment 40 is transmitted thereto and the weak current flows into the body of the person.

As described above, vibration is transmitted to the body of the person via the vibration transmission attachment 40 and a weak current is transmitted to the body of the person, so that injury or pain can be reduced. The weak current does not give an irritating stimulation, unlike a low frequency current, and an effect that recovery of body tissues is expedited can be expected.

Therefore, also in the vibration device 201 according to this embodiment, vibration and a weak current generated in accordance with a reproduction signal can be effectively used.

As has been described, each of the vibration devices 1, 1′, 101, and 201 is a palm-sized small device that can be used for body massage, myofascial release, relaxation, application of giving vibration to water (liquids in general, including drink water, alcohol, agricultural water, or the like) or used as a handy vibration machine, performs transmission of vibration by energy of sound, and has a function of an electromotive force due to vibration to give a weak current stimulation to a human body in accordance with each of complex patterns of various sound sources.

Note that the embodiments described above are merely preferable examples by nature and are not intended to be particularly limiting the present disclosure, application of the present disclosure, and the scope of use.

What is claimed is:

1. A vibration device that vibrates in accordance with a reproduction signal, comprising:
a vibration generation section including a speaker, the speaker being configured to generate a sound wave in accordance with the reproduction signal, to thereby generate vibration;
a power generation section including a piezoelectric element that generates a current corresponding to the reproduction signal by the vibration of the vibration generation section;
an electromagnetic wave generation section including a coil substrate, into which the current generated by the power generation section flows to thereby generate an electromagnetic wave that is spatially radiated; and
a body section including a cylindrical case that accommodates the vibration generation section, the power generation section, and the electromagnetic wave generation section, the vibration generated by the vibration generation section being transmitted a user via the case or an attachment section attachable to the case.

2. The vibration device according to claim 1, wherein the vibration generation section, the power generation section, and the electromagnetic wave generation section are vertically integrated in the case.

3. The vibration device according to claim 2, wherein the body section includes a container insertion-type attachment section that is attachable to an upper portion of the case, the container insertion attachment section including a container for storing liquid therein, the vibration generated by the vibration generation section and the electromagnetic wave generated by the coil substrate being transmissible to the liquid in the container.

4. The vibration device according to claim 3, wherein the container insertion-type attachment section has a cylindrical shape, covers the case from an outer side of the case, and includes a mounting portion provided in an upper portion thereof.

5. The vibration device according to claim 1, wherein
the speaker of the vibration generation section includes:
a bass sound reproduction speaker having an opening section on an upper part thereof, and
an upper speaker provided above the bass sound reproduction speaker and having a grill on the lower part thereof, a sound being emissible from the opening section and the grill.

6. The vibration device according to claim 5, wherein the piezoelectric element is arranged above the grill.

7. The vibration device according to claim 5, wherein the case has a plurality of arc-shaped notches provided at intervals at a lower end of the case.

8. The vibration device according to claim 1, wherein the vibration generation section is configured to obtain the reproduction signal via a wireless communication or from a recording medium.

9. The vibration device according to claim 1, wherein the reproduction signal includes an aperiodic continuous signal obtained through waveform synthesis by connecting analog waveforms of one cycle wavelength in succession.

10. A vibration device that vibrates in accordance with a reproduction signal, comprising:
a vibration generation section including a speaker, the speaker being configured to generate a sound wave in accordance with the reproduction signal, to thereby generate vibration;
a power generation section including a piezoelectric element that generates a current corresponding to the reproduction signal by the vibration of the vibration generation section to thereby generate an electromagnetic wave that is spatially radiated; and
a body section including a cylindrical case that accommodates the vibration generation section and the power generation section, the vibration generated by the vibration generation section being transmitted toa user via the case or an attachment section attachable to the case.

11. The vibration device according to claim 10, wherein
the speaker of the vibration generation section includes:
a bass sound reproduction speaker having an opening section on an upper part thereof, and
an upper speaker provided above the bass sound reproduction speaker and having a grill on the lower part thereof, a sound being emissible from the opening section and the grill.

12. The vibration device according to claim 11, wherein the piezoelectric element is arranged above the grill.

13. The vibration device according to claim 11, wherein
the case has a plurality of arc-shaped notches provided at intervals at a lower end of the case.

14. The vibration device according to claim 10, wherein the vibration generation section is configured to obtain the reproduction signal via a wireless communication or from a recording medium.

15. The vibration device according to claim 10, wherein the reproduction signal includes an aperiodic continuous signal obtained through waveform synthesis by connecting analog waveforms of one cycle wavelength in succession.
